(19) United States
(12) Patent Application Publication
(10) Pub. No.: US 2002/0156698 A1
(43) Pub. Date: Oct. 24, 2002

(54) Process for configuring a product or a product combination on a PC

(75) Inventors: Norbert Machau, Goppingen (DE); Hong Zhou, Deizisau (DE); Robert Lang, Esslingen (DE)

Correspondence Address: Charles R. Hoffmann, Esq., HOFFMANN & BARON, LLP, 6900 Jericho Turnpike, Syosset, NY, 11791, US

(73) Assignee: FESTO AG & CO.

(21) Appl. No.: 10/123,927

(22) Filed: Apr. 16, 2002

(30) Foreign Application Priority Data
Apr. 20, 2001 (EP) 01 710 024.9

(51) Int. Cl. G06F 17/60

(52) U.S. Cl. 705/26

(57) ABSTRACT

A process is proposed for configuring a product or a product combination on a PC, which can be connected or is connected via a data link with a data processing facility or computer of the product manufacturer. The product or product combination and/or their individual components are portrayed on the display of the PC by means of a configuration program in this computer, menu-guided on the basis of a selectable system concept for the product or product combination, where the dimensioning and working parameters (11, 12) are selected and/or fed in and the individual components required for this are automatically selected from the individual components present in the data bank of the computer and/or automatically configured or adapted. The resulting individual components are represented and/or listed. A client and user can thus configure a product himself according to his specifications in a simple manner in the case of a very large multiplicity of available individual components so that the individual components required for this are automatically selected and assembled into a product.

The invention concerns a process for configuring a product or a product combination on a PC. In a known manner, manufacturers and marketing companies currently offer an internet service in which the client obtains access to offered goods with his PC through the internet. He can see illustrations of the goods offered, including their description and prices and pick out the goods that he wants, which he places in a “market basket.” He can then order this market basket via the internet connection.

In the case of more complex commercial products that are available in very many variations and which have to be mutually adapted, the familiar way of ordering goods is no longer reasonably feasible because there are structural and adaptive requirements that disclose the product desired or required by the client and make it available only to him.

One problem of the present invention is thus to disclose a process of the above type, by which a client or other interested person can configure a product desired by him or a product combination of a specific manufacturer desired by him on his PC, also with more complex technology.

This problem is solved according to the invention by the features of claim 1.

By means of the invention process, the client or other user can access on his PC the data processing facility of the product manufacturer and configure a product that he desires or a product configuration that he desires on the basis of the desired technical specifications. The individual components required are then selected automatically or on the basis of a menu so that a functional product or a functional product combination is produced according to these specifications in a simple manner. The configuration results and the individual components required, including their technical specifications, are depicted and simulated. This opens up the possibility for the consumer to vary the dimensioning and working parameters that he wants, in which case an adaptation of the individual components or the product or the product combination then automatically occurs.

Advantageous refinements and improvements in the process specified in claim 1 are possible through the measures indicated in the dependent claims.

Standard components and, if necessary, variant products that are reconfigured and/or adapted according to the parameter specifications are first advantageously selected, where nonpractical parameter combinations are preferably indicated. The invention process is thus based on the use of standard components and accesses variant products that are individually configured and adapted to the client's wishes. New products more or less constructed by the client thus result, which can still be actualized by the product manufacturer.

The configuration, adaptation and preferably also the simulation are program-controlled and automatic according to the parameter specifications so that with a change in a dimensioning and working parameter the client immediately discerns the consequences resulting for the configured product and can also determine whether such a parameter combination is technically feasible at all.

The depiction of the products, product combinations and/or individual components is expediently obtained from a CAD data bank and/or is generated in running time, which is visually adapted by a CAD program with regard to appropriate reconstruction or adaptation, where the depiction is preferably two- or three-dimensional. The possibility of visual adaptation makes it possible for the user to get an impression of the product or product combination configured by him and facilitates his assessment whether the product in this manner is desired or usable by him.

To facilitate and simplify the configuration, the dimensioning and parameterization of the products, product combinations and/or individual components are effected by means of display masks and appropriate input windows that simultaneously open up and also limit the given possibilities for the user.

With exchange and/or modification of an individual component the other individual components are advantageously adapted and/or exchanged functionally correctly so that the functionality of the configured product or product combination is retained in each case.

In another advantageous implementation of the process, the required accessory parts are automatically selected and proposed and/or inserted into the product or product combination. Through this, formation of an incomplete product or incomplete production combination is prevented. All the technically required individual components and accessory parts are thus automatically added to the configuration.

In order to be able to actualize the configured product and the configured product combination in practice also, a product list is prepared by menu according to the configuration in an additional implementation of the process and is preferably introduced into a market basket. It is also advantageous that the product lists be automatically tested and the availability dates and/or prices be transmitted.

The data can be called in via the data connection of the data processing facility of the product manufacturer, but it has also proven expedient to store the configuration program and/or the product data at least partially on a data carrier, e.g., a CD or DVD data carrier that is used in the PC of the user. An acceleration of the configuration can thus be achieved, especially with regard to the transfer rate of large amounts of data such as picture data via the internet.

The process according to the invention is elucidated in the following on the basis of implementation examples.

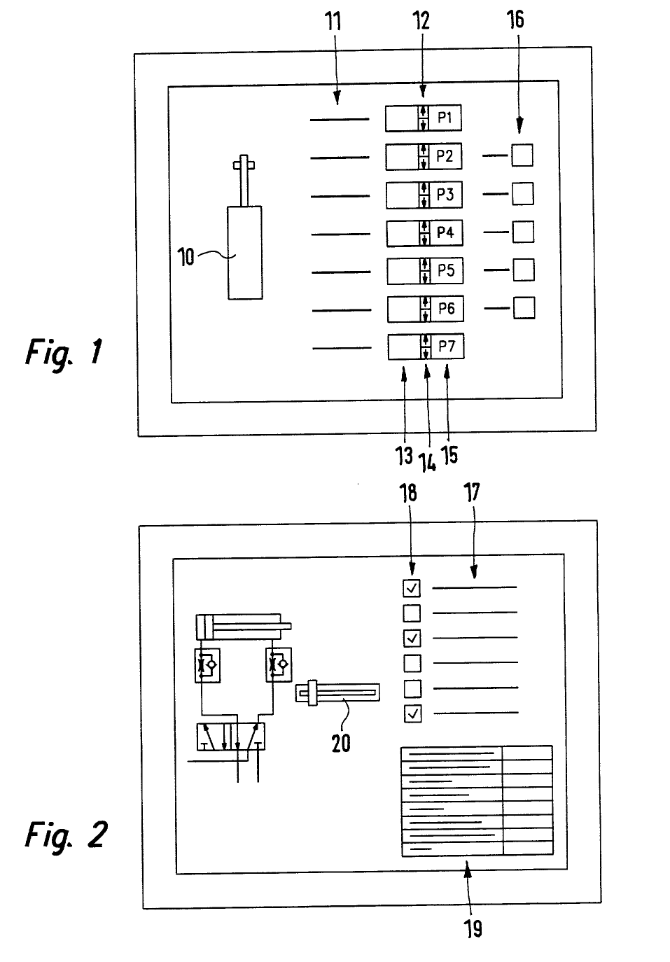

FIG. 1 shows a menu representation for parameterizing a linear drive.

And FIG. 2 shows a menu view for component selection and for reproduction of the properties calculated.

To configure a specific product or a product combination, the client or user selects the data processing facility of the product manufacturer with the aid of his PC personal computer) via the internet. He obtains from this the pertinent internet address that permits him access to the configuration program in the data processing facility of the product manufacturer. In addition, a data carrier, e.g., a CD or DVD data carrier, can be placed at his disposal by the product manufacturer, on which are located parts of the configuration program or program data, in order not to have to call in all the data via the internet or another network.

If a connection is made with the configuration program, a selection is first made between different system concepts guided by the menu. Such system concepts are of course dependent on the pertinent branch and the product range of the manufacturer. In the case of a manufacturer of pneumatic components, they can be, e.g., linear drives, rotating drives, valve islands or arrangements, robotic devices or the like. The input of subgroups of such system concepts is also possible, e.g., in the case of nonpiston rod drives or piston drives.

In the embodiment shown a linear drive is selected as the system concept. For parameterization, a display mask according to FIG. 1 is called in, in which a linear drive 10 is first depicted schematically in the form of a working cylinder 10 and the parameterization possibilities are listed on it. Input windows 12 are given for the parameters P1 to P7 alongside. Besides the actual number of input windows 13, they contain mouse control fields 14 for increasing and reducing the numerical values as well as unit windows 15 for reproduction of pertinent technical or physical units. These parameters P1-P7 involve, e.g., floating times, floating rates, stroke, cylinder length, power, mass moved, geometric dimensioning and the like. A menu sequence window range 16 permits back and forth transitions to other menu windows.

After parameterization, a changeover to selection menu windows (not shown) can occur, through which a selection can be made between the various possible individual components that in principle can meet the provisions according to FIG. 1. The components can be presented two- or three-dimensionally as CAD designs, where the required data are taken from a CAD storage or automatically generated in running time. Standard products or so-called variant products can be involved here. Variant products are products that are not standard products and can be configured practically arbitrarily relative to their length, diameter, material and the like. Depending on the parameterization, the variant product involved is then automatically configured and provided with a specific type number that is typical for the configured variant product and is duplicatable for production.

After the selection steps or directly after the parameterization, [one] can switch through the result menu shown in FIG. 2. The linear drive with all the required components is shown there. The individual components are listed in a component list 17 and can be selected or confirmed through the selection windows 18. These selection windows 18 can also be provided optionally only in a portion of the components, while urgently required components remain without the possibility of selection. The calculated properties of the overall product selected are calculated and reproduced on the basis of the individual components and their combination in a result protocol 19, e.g., the average rate, the maximum rate, kinetic energy, the through-flow rate, air consumption, energy and performance data and the like. Various parameters and settings can now be optionally modified and the results simulated. For this, either access can be made to the parameterization menu according to FIG. 1, or parameters are modified, e.g., with the mouse via the represented adjusting slider 20. The adjusting slider 20 shown serves, e.g., to modify the air throughflow rate. In accordance with this modification, the individual components are then automatically adapted or modified, or additional components are required, e.g., limit stop damper, noise damper, check valves, additional valves or the like. They supplement the component list 17 and can be selected there. Optionally, information then appears in that the desired parameterization can be actualized only if these additional components are added. By actuating the corresponding selection window 18, the component to be added is then introduced into the pictorial representation, included in the calculation and considered in the result protocol 19.

The results menu according to FIG. 2 can of course have the menu sequence function range 16 according to FIG. 1 in order to effect transitions to other menus. For example, appropriate menu windows can be called in to exchange individual components and another can be selected from the list of alternative components. This component is then included in the overall product according to FIG. 2 automatically or by an appropriate input command and considered both graphically and by calculation.

The required accessory parts such as connecting hoses, connection elements, electrical components, gaskets, fasteners, housings and the like are either automatically proposed in a menu window according to FIG. 2 or a similar menu window and can be selected then, or an accessory menu window has to be specifically selected. Only the accessory parts that can be used or are even required for the product selected are presented or proposed here. These accessory parts can again be modified and adapted to the components.

1. Process for configuring a product or a product combination on a PC (personal computer) that is connectable or is connected via a data link with a computer of the product manufacturer, where it and/or its individual components are depicted on the screen of the PC by means of a configuration program on this computer that is menu-guided on the basis of a selectable system concept for the product or the product combination, in which case the dimensioning and working parameters (11, 12) are selected and/or fed in and the individual components required for this are automatically selected (17, 18) from the individual components present in the data bank of the computer and/or automatically configured or adapted, and where the resulting individual components are displayed and/or listed.

2. Process according to claim 1, characterized in that standard components are first selected and, if necessary, variant products, which are reconfigured and/or adapted according to the parameter specifications, where nonrealistic parameter combinations are preferably shown and/or additionally required components are proposed for such parameter combinations.

3. Process according to claim 2, characterized in that the configuration and adaptation and preferably also the simulation are automatically program-guided in accordance with the parameter specifications or occur after being called up.

4. Process according to one of the preceding claims, characterized in that the representation of the products, product combinations and/or individual components is taken from a CAD data bank and/or generated in running time and is visually adapted by reconstruction or adaptation by a CAD program, in which case the representation is preferably two- or three-dimensional and/or as a cross-sectional presentation.

5. Process according to claim 4, characterized in that the configured product and/or product combination is reproduced in its mode of function and/or movement or that appropriate function diagrams are reproduced or can be called in.

6. Process according to one of the preceding claims, characterized in that the dimensioning and parameterization of the products, product combinations and/or individual components are done by display masks and appropriate input windows.

7. Process according to one of the preceding claims, characterized in that with the exchange and/or modification of an individual component the other individual components are correspondingly adapted functionwise and/or exchanged or proposed for adaptation or exchange.

8. Process according to one of the preceding claims, characterized in that the required accessory parts are automatically selected and proposed and/or inserted into the product or the product combination.

9. Process according to one of the preceding claims, characterized in that a product list is prepared menu-guided according to the configuration, which list preferably can be placed in a market basket.

10. Process according to claim 9, characterized in that the product list is automatically tested and the availability data and/or price are transmitted.

11. Process according to one of the preceding claims, characterized in that the configuration program and/or product data are stored at least partially in a data carrier, especially a CD or DVD data carrier, which is used in the PC of the user.
